(19) United States
(12) Patent Application Publication
(10) Pub. No.: US 2006/0143400 A1
(43) Pub. Date: Jun. 29, 2006

(54) Replacement in non-uniform access cache structure

(76) Inventor: Simon C. Steely JR., Hudson, NH (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/025,537

(22) Filed: Dec. 29, 2004

(51) Int. Cl. G06F 13/00

(52) U.S. Cl. 711/136

(57) ABSTRACT

An embodiment of the present invention is a technique to perform replacement in a non-uniform access cache structure. A cache memory stores data and associated tags in a non-uniform access manner. The cache memory has a plurality of memory banks arranged according to a distance hierarchy with respect to one of a processor and a processor core. The distance hierarchy includes a lowest latency bank and a highest latency bank. A controller performs a non-uniform pseudo least recently used (LRU) replacement on the cache memory.

### BACKGROUND

1. Field of the Invention

Embodiments of the invention relate to the field of microprocessors, and more specifically, to cache memory.

2. Descripton of Related Art.

As microprocessor architecture becomes more and more complex to support high performance applications, the design for efficient memory accesses becomes a challenge. In particular, cache memory structures pose many design problems, such as demands for large cache size and low latency. Large cache memory units typically have a number of memory arrays located close to, or inside, the processor. Due to constraints in physical space, the arrays are spread out throughout the device or the board and connected through long wires. These long wires cause significant delays or latency in access cycles. Wire delays have become a dominant latency component and have a significant effect on processor performance.

Existing techniques addressing the problem of wire delays in cache structures have a number of disadvantages. One technique attempts to improve the average latency of a cache hit by migrating the data among the levels. This technique complicates the cache control, introduces race conditions, and uses more power. Another technique decouples the data placement from the tag placement. This technique requires complex design of the cache arrays and the cache controller.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a non-uniform access cache structure according to one embodiment of the invention.

FIG. 3 is a flowchart illustrating a process to perform a non-uniform pseudo least recently used replacement according to one embodiment of the invention.

FIG. 4 is a flowchart illustrating a process to perform cache miss operation in the non-uniform pseudo least recently used replacement according to one embodiment of the invention.

### DESCRIPTION

An embodiment of the present invention is a technique to perform replacement in a non-uniform access cache structure. A cache memory stores data and associated tags in a non-uniform access manner. The cache memory has a plurality of memory banks arranged according to a distance hierarchy with respect to one of a processor and a processor core. The distance hierarchy includes a lowest latency bank and a highest latency bank. A controller performs a non-uniform pseudo least recently used (LRU) replacement on the cache memory.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to perform replacement of cached lines in a non-uniform access cache structure. The replacement increases the hit ratio in the lowest latency bank(s) and reduces the hit ratio in the highest latency bank(s), leading to improved processor speed performance. The technique may be implemented by simple logic circuits that are no more complex than a conventional cache controller.

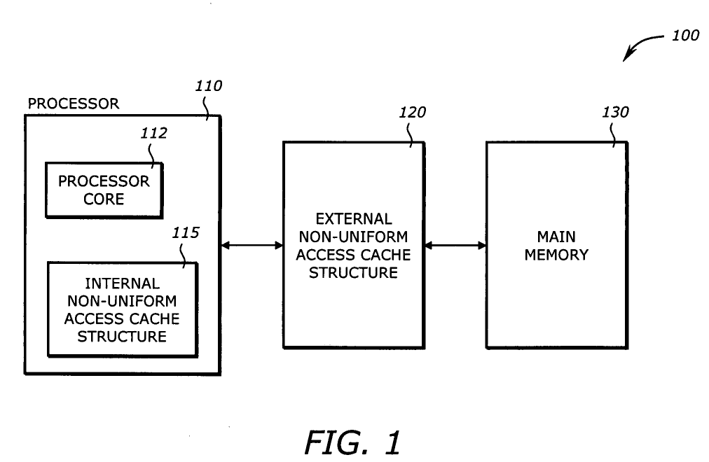

FIG. 1 is a diagram illustrating a system 100 in which one embodiment of the invention can be practiced. The system 100 includes a processor 110, an external non-uniform access cache structure 120, and a main memory 130.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. It includes a processor core 112 and may include an internal NUA cache structure 115. It is typically capable of generating access cycles to the main memory 130 or the internal or external NUA cache structures 115 or 120. The system 110 may have one or both of the internal or external NUA cache structures 115 or 120. In addition, there may be several hierarchical cache levels in the external NUA cache structure 120.

The internal or external NUA cache structures 115 or 120 are similar. They may include data or instructions or both data and instructions. They typically include fast static random access memory (RAM) devices that store frequently accessed data or instructions in a manner well known to persons skilled in the art. They typically contain memory banks that are connected with wires, traces, or interconnections. These wires or interconnections introduce various delays. The delays are non-uniform and depend on the location of the memory banks in the die or on the board. The external NUA cache structure 120 is located externally to the processor 110. It may also be located inside a chipset such as a memory controller hub (MCH), an input/output (I/O) controller hub (ICH), or an integrated memory and I/O controller. The internal or external NUA cache structures 115 or 120 includes a number of memory banks that have non-uniform accesses with respect to the processor core 112 or the processor 110, respectively.

The main memory 130 stores system code and data. It is typically implemented with dynamic random access memory (DRAM) or static random access memory (SRAM). When there is a cache miss, the missing information is retrieved from the main memory and is filled into a suitably selected location in the cache structure 115 or 120. The main memory 130 may be controlled by a memory controller (not shown).

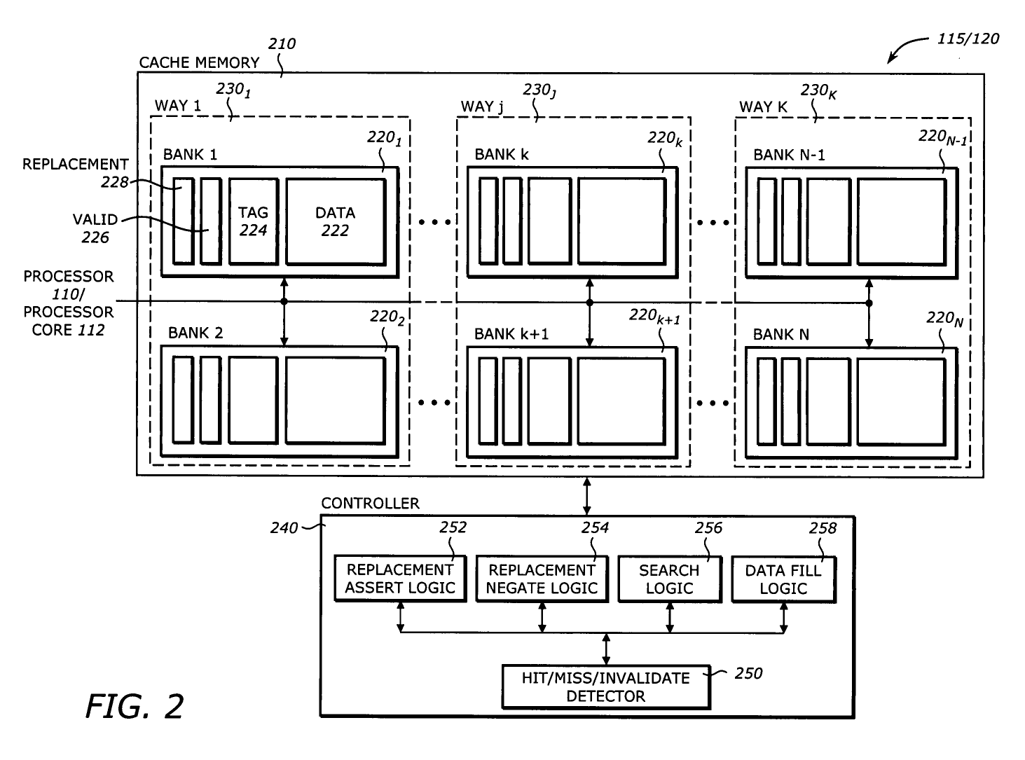

FIG. 2 is a diagram illustrating the non-uniform access cache structure 115/120 according to one embodiment of the invention. The NUA cache structure 115/120 includes a cache memory 210 and a controller 240.

The cache memory 210 store data and associated tags in a non-uniform access manner. It includes N memory banks 220₁ to 220_{N}, where N is a positive integer, arranged according to a distance hierarchy with respect to the processor 110 or the processor core 112. The distance hierarchy refers to the several levels of delay or access time. The distance includes the accumulated delays caused by interconnections, connecting wires, stray capacitance, gate delays, etc. It may or may not be related to the actual distance from a bank to an access point. The access point is a reference point where access times are computed from. This accumulated delay or access time is referred to as the latency. The distance hierarchy includes a lowest latency bank and a highest latency bank. The lowest latency bank is the bank that has the lowest latency or shortest access time with respect to a common access point. The highest latency bank is the bank that has the highest latency or longest access time with respect to a common access point. The N memory banks 220₁ to 220_{N} form non-uniform latency banks ranging from the lowest latency bank to the highest latency bank. Each memory bank may include one or more memory devices.

The N memory banks 220₁ to 220_{N} are organized into K ways 230₁ to 230_{K}, where K is a positive integer, in a K-way set associative structure. The N memory banks 220₁ to 220_{N} may be laid out or organized into a linear array, a two-dimensional array, or a tile structure. Each of the N memory banks 220₁ to 220_{N} may include a data storage 222, a tag storage 224, a valid storage 226, and a replacement storage 228. The data storage 222 stores the cache lines. The tag storage 224 stores the tags associated with the cache lines. The valid storage 226 stores the valid bits associated with the cache lines. The replacement storage 228 stores the replacement bits associated with the cache lines. When a valid bit is asserted (e.g., set to logic TRUE), it indicates that the corresponding cache line is valid. Otherwise, the corresponding cache line is invalid. When a replacement bit is asserted (e.g., set to logic TRUE), it indicates that the corresponding cache line has been accessed recently. Otherwise, it indicates that the corresponding cache line has not been accessed recently. Any of the storages 222, 224, 226, and 228 may be combined into a single unit. For example, the tag and replacement bits may be located together and accessed in serial before the data is accessed.

The controller 240 controls the cache memory 210 in various cache operations. These cache operations may include placement, eviction or replacement, filling, coherence management, etc. In particular, it performs a non-uniform pseudo least recently used (LRU) replacement on the cache memory 210. The non-uniform pseudo LRU replacement is a technique to replace or evict cache data in a way when there is a cache miss. The controller 240 includes a hit/miss/invalidate detector 250, a replacement assert logic 252, a replacement negate logic 254, a search logic 256, and a data fill logic 258. Any combination of these functionalities may be integrated or included in a single unit or logic. Note that the controller 240 may contain more or fewer than the above components. For example, it may contain a cache coherence manager for uni- or multi-processor systems.

The detector 250 detects if there is a cache hit, a cache miss, or an invalidate probe. It may include a snooping logic to monitor bus access data and comparison logic to determine the outcome of an access. It may also include an invalidation logic to invalidate a cache line based on a pre-defined cache coherence protocol.

The replacement assert logic 252 asserts (e.g., sets to logical TRUE) a replacement bit corresponding to a line when there is a hit to the line as detected by the detector 250. It may also assert replacement bits in other conditions. For example, it may assert a negated replacement bit when a cache line is invalidated by an invalidate probe, or assert a replacement bit on a fill.

The replacement negate logic 254 negates (e.g., clears to logical FALSE) a replacement bit corresponding to a line when there is an invalidate probe to the line as detected by the detector 250. It may also negate the replacement bits in other conditions. For example, it may negate all replacement bits in a set if all the replacement bits are asserted.

The search logic 256 searches for a way in the K ways 230₁ to 230_{K} for replacement using the non-uniform pseudo LRU replacement when there is a cache miss. When there is a cache miss, the search logic 256 determines if there is any invalid line in the set as indicated by the valid bits. If so, it selects the way having an invalid line. If not, the search logic 256 determines if all the replacement bits in a set are asserted. If so, the replacement negate logic negates all of these replacement bits. Then the search logic 256 searches for the way to be used in the replacement from the highest latency bank to the lowest latency bank. It then selects the way having a negated replacement bit.

The data fill logic 258 fills the data retrieved either from a higher level cache or the main memory 130 into the way selected by the search logic 256 as above. After the data is filled, the replacement assert logic asserts the corresponding replacement bit as discussed above.

The non-uniform pseudo LRU replacement technique has a property that lines located closest to the starting search point are more likely to be replaced than those that are further away. Busy, or hot or frequently accessed, lines are naturally sorted to locate far from the search point. This happens naturally as busy lines are displaced, they are randomly located back into a way. When they are located in a way far from the starting search point, they live longer in the cache memory. This is because to be replaced, they are required to not be accessed before all the closer ways have either been accessed or replaced into. If they are accessed in that interval, then they live across another generation of the non-uniform pseudo LRU replacement and only become vulnerable for replacement when all the replacement bits are negated again. When this replacement scheme is applied to the non-uniform access cache structure 115/120, the search point starts from the longest latency bank toward the lowest latency bank. In this manner, the lowest latency bank, which is located the farthest from the starting search point, contains the lines that live longer than those in the longest latency banks, thus leading to a higher hit ratio. A higher hit ratio in the lowest latency bank leads to higher processor speed performance.

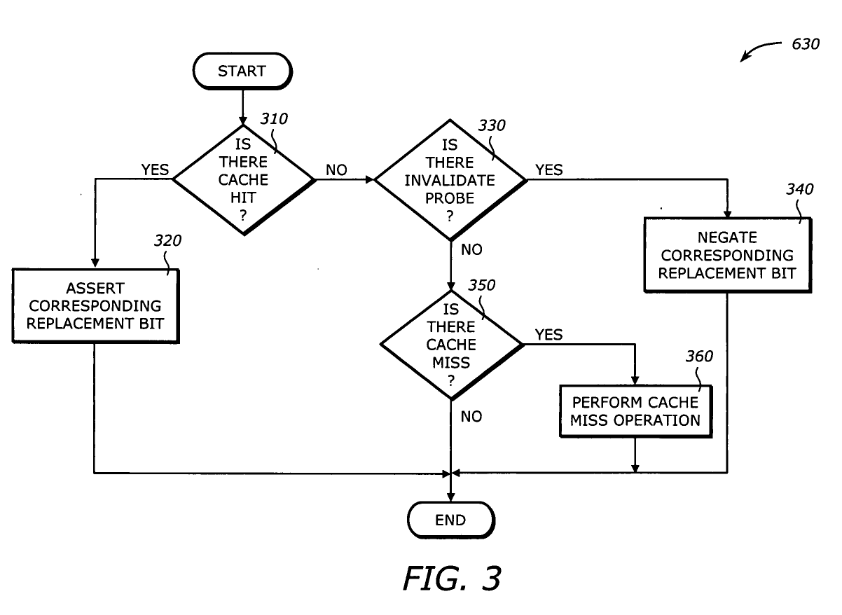

FIG. 3 is a flowchart illustrating a process 300 to perform a non-uniform pseudo least recently used replacement according to one embodiment of the invention.

Upon START, the process 300 determines if there is a cache hit (Block 310). If so, the process 300 asserts the corresponding replacement bit (Block 320) and is then terminated. Otherwise, the process 300 determines if there is any invalidate probe to a line (Block 330). If so, the process 300 negates the corresponding replacement bit (Block 340) and is then terminated. Otherwise, the process 300 determines if there is any cache miss (Block 350). If so, the process 300 performs a cache miss operation (Block 360) and is then terminated. Otherwise, the process 300 is terminated.

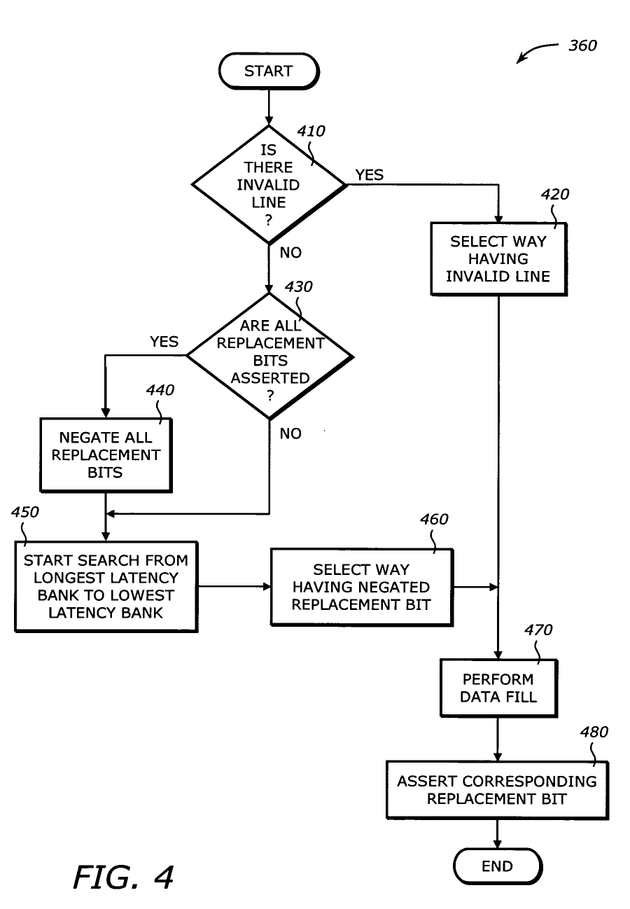

FIG. 4 is a flowchart illustrating the process 360 to perform cache miss operation in the non-uniform pseudo least recently used replacement according to one embodiment of the invention.

Upon START, the process 360 determines if there is an invalid line in the set (Block 410). If so, the process 360 selects the way that has the invalid line (Block 420) and proceeds to Block 470. Otherwise, the process 360 determines if all the replacement bits in the set are asserted (Block 430). If so, the process 360 negates all the replacement bits (Block 440) and proceeds to Block 450. Otherwise, the process 360 starts searching from the longest latency bank to the lowest latency bank (Block 450).

Then, the process 360 selects the way that is first encountered and has a negated replacement bit (Block 460). Next, the process 360 performs the data filling (Block 470). This can be performed by retrieving the data from the higher level cache or from the main memory and writing the retrieved data to the corresponding location in the cache memory. Then, the process 360 asserts the corresponding replacement bit (Block 480) and is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a cache memory to store data and associated tags in a non-uniform access manner, the cache memory having a plurality of memory banks arranged according to a distance hierarchy with respect to a processor, the distance hierarchy including a lowest latency bank and a highest latency bank; and
a controller coupled to the cache memory to perform a non-uniform pseudo least recently used (LRU) replacement on the cache memory.

2. The apparatus of claim 1 wherein the plurality of memory banks is organized into a plurality of ways in a K-way set associative structure.

3. The apparatus of claim 2 wherein the controller comprises:
a replacement assert logic to assert a replacement bit corresponding to a line when there is a hit to the line;
a replacement negate logic to negate a replacement bit corresponding to a line when there is an invalidate probe to the line; and
a search logic to search for a way in the plurality of ways for replacement using the non-uniform pseudo LRU replacement when there is a miss.

4. The apparatus of claim 3 wherein the search logic selects the way having an invalid line.

5. The apparatus of claim 3 wherein the replacement negate logic negates all replacement bits in a way if all the replacement bits are asserted.

6. The apparatus of claim 3 wherein the search logic searches for the way from the highest latency bank to the lowest latency bank.

7. The apparatus of claim 6 wherein the search logic selects the way having a negated replacement bit.

8. The apparatus of claim 7 wherein the replacement assert logic asserts the replacement bit on data filling into the selected way occurs.

9. The apparatus of claim 1 wherein the plurality of memory banks forms into one of a linear array, a two-dimensional array, and a tile structure.

10. The apparatus of claim 1 wherein the plurality of memory banks forms non-uniform latency banks ranging from the lowest latency bank to the highest latency bank.

11. A method comprising:
storing data and associated tags in a cache memory in a non-uniform access manner, the cache memory having a plurality of memory banks arranged according to a distance hierarchy with respect to a processor, the distance hierarchy including a lowest latency bank and a highest latency bank; and
performing a non-uniform pseudo least recently used (LRU) replacement on the cache memory.

12. The method of claim 11 wherein storing comprises storing the data and associated tags in the cache memory having the plurality of memory banks organized into a plurality of ways in a K-way set associative structure.

13. The method of claim 12 wherein performing the non-uniform pseudo LRU replacement comprises:
asserting a replacement bit corresponding to a line when there is a hit to the line;
negating a replacement bit corresponding to a line when there is an invalidate probe to the line; and
searching for a way in the plurality of ways for replacement using the non-uniform pseudo LRU replacement when there is a miss.

14. The method of claim 13 wherein searching comprises selecting the way having an invalid line.

15. The method of claim 13 wherein negating comprises negating all replacement bits in a way if all the replacement bits are asserted.

16. The method of claim 13 wherein searching comprises searching for the way from the highest latency bank to the lowest latency bank.

17. The method of claim 16 wherein searching comprises selecting the way having a negated replacement bit.

18. The method of claim 17 wherein asserting comprises asserting the replacement bit on data filling into the selected way occurs.

19. The method of claim 11 wherein the plurality of memory banks forms into one of a linear array, a two-dimensional array, and a tile structure.

20. The method of claim 11 wherein the plurality of memory banks forms a non-uniform latency banks ranging from the lowest latency bank to the highest latency bank.

21. A system comprising:
a processor having a processor core;
a main memory coupled to the processor; and
a cache structure coupled to one of the processor and the processor core and the main memory, the cache structure comprising:
a cache memory to store data and associated tags in a non-uniform access manner, the cache memory having a plurality of memory banks arranged according to a distance hierarchy with respect to the one of the processor and the processor core, the distance hierarchy including a lowest latency bank and a highest latency bank, and
a controller coupled to the cache memory to perform a non-uniform pseudo least recently used (LRU) replacement on the cache memory.

22. The system of claim 21 wherein the plurality of memory banks is organized into a plurality of ways in a K-way set associative structure.

23. The system of claim 22 wherein the controller comprises:
a replacement assert logic to assert a replacement bit corresponding to a line when there is a hit to the line;
a replacement negate logic to negate a replacement bit corresponding to a line when there is an invalidate probe to the line; and
a search logic to search for a way in the plurality of ways for replacement using the non-uniform pseudo LRU replacement when there is a miss.

24. The system of claim 23 wherein the search logic selects the way having an invalid line.

25. The system of claim 23 wherein the replacement negate logic negates all replacement bits in a way if all the replacement bits are asserted.

26. The system of claim 23 wherein the search logic searches for the way from the highest latency bank to the lowest latency bank.

27. The system of claim 26 wherein the search logic selects the way having a negated replacement bit.

28. The system of claim 27 wherein the replacement assert logic asserts replacement bit on data filling into the selected way occurs.

29. The system of claim 21 wherein the plurality of memory banks forms into one of a linear array, a two-dimensional array, and a tile structure.

30. The system of claim 21 wherein the plurality of memory banks forms non-uniform latency banks ranging from the lowest latency bank to the highest latency bank.
